(19) United States
(12) Patent Application Publication
(10) Pub. No.: US 2004/0173446 A1
(43) Pub. Date: Sep. 9, 2004

(54) Vehicle rear door opening switch equipped with lighting means

(76) Inventors: Miquel Plana-Bague, Barcelona (ES); Jose Antonio Herrero, Barcelona (ES)

Correspondence Address: Liniak Berenato, Longacre & White, Suite 240, 6550 Rock Spring Drive, Bethesda, MD, 20817, US

(21) Appl. No.: 10/486,374

(22) PCT Filed: Aug. 28, 2002
(86) PCT No.: PCT/EP02/09589

(30) Foreign Application Priority Data
Aug. 28, 2001 (ES) 200201970

(51) Int. Cl. H01H 9/00

(52) U.S. Cl. 200/314

(57) ABSTRACT

A switch that is used to open vehicle rear doors or openings comprising means for manually actuating the lock. Said means comprise a plastic or elastomer membrane (3) which is pressed by the user in order to actuate the lock. The plastic or elastomer membrane (3) is partially translucent and a light source (5) is housed inside the switch.

The present invention relates to a vehicle tailgate or door opening switch, of the type manually actuated by the user in order to open the lock of the opening leaf (door or tailgate), after the lock has been unlocked by means of the corresponding catch.

### PRIOR ART OF THE INVENTION

Switches applicable in the tailgate and side doors of vehicles are known, these switches comprising a flexible membrane, in particular made of a black elastomer, which surrounds a microswitch. When the user presses the flexible membrane with his fingers, he actuates the microswitch and a corresponding relay causes the lock to open.

As an example, Spanish patent application No. 99/00840, the proprietor of which is the same as that of the present application, discloses a switch for a vehicle door in which the lock is opened by means of a microswitch; the switch comprises a case provided with an opening closed by a membrane, by means of which a user presses on an actuating bar, the displacement of which acts on the contact of the microswitch.

Although these switches operate satisfactorily, they do have the drawback that, when the user has to open the door of the vehicle at night or in a dark place, it is difficult for him to locate the position of the switch and of the membrane that he has to press.

### DESCRIPTION OF THE INVENTION

The objective of the opening switch of the present invention is to remedy the drawbacks of the devices known in the prior art, by proposing for this purpose a switch that can be located and actuated easily under low-light conditions.

The switch of the present invention comprises means for actuating a lock, said means comprising a plastic or elastomeric membrane which is pressed in order to actuate the lock, and is characterized in that the plastic or elastomeric membrane is at least partly translucent and in that a light source is housed inside the switch.

Thanks to these features, the user locates the switch more easily. Moreover, the translucent membrane allows the light source in the switch to be located and avoids having to modify in any way the body of the vehicle, so that this solution is inexpensive.

In addition, the fact of placing the light inside the switch allows it to be better protected and makes its simpler to mount it.

Said membrane is preferably at least partly transparent.

In one embodiment, the membrane is a single part and is translucent or transparent in its entirety.

In an alternative embodiment, the membrane is only partly translucent or transparent; in this case, the membrane may be formed from two parts joined together.

Advantageously, the switch furthermore includes means for turning said light source on, said means being associated with a catch for unlocking the lock.

As a consequence, the light is turned on only when the user actuates the remote control in order to effect the unlocking operation, before acting on the switch, without unnecessary consumption of energy.

### BRIEF DESCRIPTION OF THE DRAWINGS

To make the description of what has been explained above easier to understand, a drawing is attached in which one practical embodiment of the switch of the invention is shown schematically and solely by way of non-limiting example, in which:

FIG. 1 is a view of the inside part of the opening switch of the invention.

### DESCRIPTION OF A PREFERRED EMBODIMENT

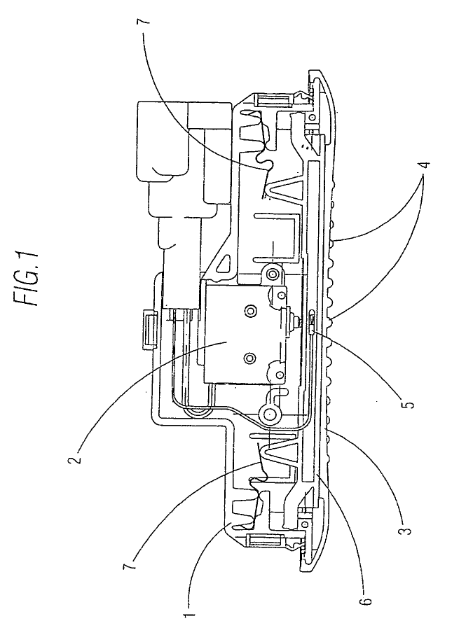

As may be understood from FIG. 1, the switch of the invention, applicable for example to a vehicle tailgate or door, comprises a case, identified by the reference 1, provided with conventional elements allowing it to be fitted into the vehicle and containing a microswitch 2. Said case 1 furthermore includes a membrane 3, the outer face of which has a plurality of projections 4 which make it more pleasant to touch.

Inside the case 1 is also a rigid plastic part 6 constituting the actuator of the switch 2. Said part initially remains separated from the microswitch 2 by two resilient elements 7 placed on each side of the entire switch of the invention. When the user presses the flexible membrane 3, the part 6 is pushed toward the microswitch 2 and a corresponding relay causes the lock to open. As soon as the user stops exerting pressure on the membrane 3, the part 6 returns to its initial position, thanks to the abovementioned resilient elements 7.

Inside the switch is also, in accordance with the invention, a small lamp 5 that provides sufficient light to be visible from the outside, so as to indicate the switch under low-light conditions.

To do this, in accordance with the invention, the membrane 3, which may be made of a plastic or an elastomer, is translucent.

In the present specification, the concept of “translucency” refers to the ability of allowing light to pass, and it also encompasses in this regard the concept of “transparency”.

The membrane may be translucent or transparent in its entirety, or else it may comprise only a translucent or transparent region through which light can pass; in the latter case, the membrane may be made from a single part or else may have two parts joined together.

In one embodiment, the light of the device is turned on when the user unlocks the lock, for example by means of the remote control; to do this, the switch has suitable actuation means, these being connected for example to the same electronic control element that unlocks the lock.

The supply source for the lamp 5 is the battery of the vehicle, which in turn supplies the microswitch 2. The inclusion of the lamp in the switch therefore requires no substantial modifications of the latter since the battery voltage is already present in this region.

The materials employed in the manufacture of the constituent elements of the opening switch that has just been described are independent of the subject matter of the present invention, just as the shapes and dimensions of the latter, together with all the ancillary details that it is likely to have, which may be replaced with other technically equivalent elements without in any way departing from the scope of the protection defined in the claims appended hereto.

As an example, although a lamp was mentioned as light source, this could be replaced with any other type of illumination, for example LEDs or the like.

1. A switch (1) for opening doors and rear opening leaves of a vehicle, comprising means for actuating a lock, said means comprising a plastic or elastomeric membrane (3) which is pressed in order to actuate the lock, characterized in that said plastic or elastomeric membrane is at least partly translucent and in that a light source (5) is housed inside the switch.

2. The switch as claimed in claim 1, characterized in that said membrane (3) is at least partly transparent.

3. The switch as claimed in either of claim 1 or 2, characterized in that the membrane (3) is a single part and is translucent or transparent in its entirety.

4. The switch as claimed in either of claim 1 or 2, characterized in that the membrane (3) is only partly translucent or transparent.

5. The switch as claimed in claim 4, characterized in that the membrane (3) is formed from two parts joined together.

6. The switch as claimed in claim 1, characterized in that it furthermore includes means for turning said light source on, said means being associated with a catch for unlocking the lock.
